(19) United States
(12) Patent Application Publication
(10) Pub. No.: US 2012/0181865 A1
(43) Pub. Date: Jul. 19, 2012

(54) DISTRIBUTED DC POWER SYSTEMS

(75) Inventor: Subramanian Muthu, Portland, OR (US)

(73) Assignee: LEVITON MANUFACTURING CO., INC., Melville, NY (US)

(21) Appl. No.: 13/007,287

(22) Filed: Jan. 14, 2011

(51) Int. Cl. H02J 4/00

(52) U.S. Cl. 307/26

(57) ABSTRACT

A power distribution unit includes one or more first terminals to connect the unit to a building power wiring line circuit, one or more second terminals to connect the unit to a building power wiring load circuit, a power supply coupled between the first terminals and the second terminals to convert power from the building power wiring line circuit to DC power for the building power wiring load circuit, and a transmitter adapted to modulate a data signal on the DC power. A method includes disconnecting a building power wiring load circuit from a relay and an AC load, and connecting a DC power supply and a DC load to the building power wiring load circuit.

### BACKGROUND

FIG. 1 illustrates a prior art relay-based lighting control system. A relay cabinet 10 includes relays 12 that control the flow of AC power to AC lighting loads 14 on various lighting circuits. Each relay has a line connection 18 that continuously receives AC power from a corresponding circuit breaker at a circuit breaker panel, and a load connection 20 that provides AC power to a corresponding lighting circuit when the relay contacts are closed.

A control module 22 controls the relays through control connections 13 in response to various types of input devices 24 such as low voltage switches, digital switches, occupancy sensors, and photocells, as well as timers and calendars which may be separate external components and/or implemented within the control module itself. The inputs are typically connected to the control module through low-voltage signal wiring 26 that is separate from the building power wiring 28 that connects the relays to the lighting loads.

The building power wiring 28 includes the load conductors 16, neutral conductors N, and ground conductors that are enclosed in conduits or cables and permanently installed in or on the building. The neutral conductors from the lighting loads typically pass through the relay cabinet 10 and back to the circuit breaker panel, but are not illustrated fully in this figure so as not to obscure the relay wiring. Alternatively, the load conductors 16 may be routed back to the circuit breaker panel where they may be routed with the corresponding neutral conductors to the lighting loads.

The ground conductors, which are also not illustrated to prevent obscuring the relay wiring, may be separate dedicated conductors or may take the form of the conduit or cable sheathing if the conduit or sheathing is metallic.

Some types of loads such as dimmable ballasts and variable speed fans may operate at variable power levels that are controlled within the load itself. These loads must be provided with a control signal that is typically wired with low-voltage signal wiring which is also separate from the building power wiring 28. Some of the low-voltage signal wiring 30 runs from the control module 22 to the loads 14, while other low voltage signal wiring 31 may be routed through a relay module 12A.

### BRIEF DESCRIPTION OF THE DRAWINGS

FIG. 1 illustrates a prior art relay-based lighting control system.

FIG. 2 illustrates an example embodiment of a lighting control system and installation method according to some inventive principles of this patent disclosure.

FIG. 3 illustrates an embodiment of a control module for a DC power distribution system according to some inventive principles of this patent disclosure.

FIG. 4 illustrates an embodiment of a DC power supply for a DC power distribution system according to some inventive principles of this patent disclosure.

FIG. 5 illustrates an embodiment of a ballast for a DC power distribution system according to some inventive principles of this patent disclosure.

FIG. 6 illustrates an embodiment of an input/display device for a DC power distribution system according to some inventive principles of this patent disclosure.

FIG. 7 illustrates another embodiment of a power distribution and control system according to some inventive principles of this patent disclosure.

FIG. 8 illustrates another embodiment of a power distribution and control system according to some inventive principles of this patent disclosure.

FIG. 9 illustrates another embodiment of a DC power supply for a DC power distribution system according to some inventive principles of this patent disclosure.

FIG. 10 illustrates an embodiment of a ballast for a DC power distribution system according to some inventive principles of this patent disclosure.

FIG. 11 illustrates an embodiment of a method for limiting inrush current according to some inventive principles of this patent disclosure.

### DETAILED DESCRIPTION

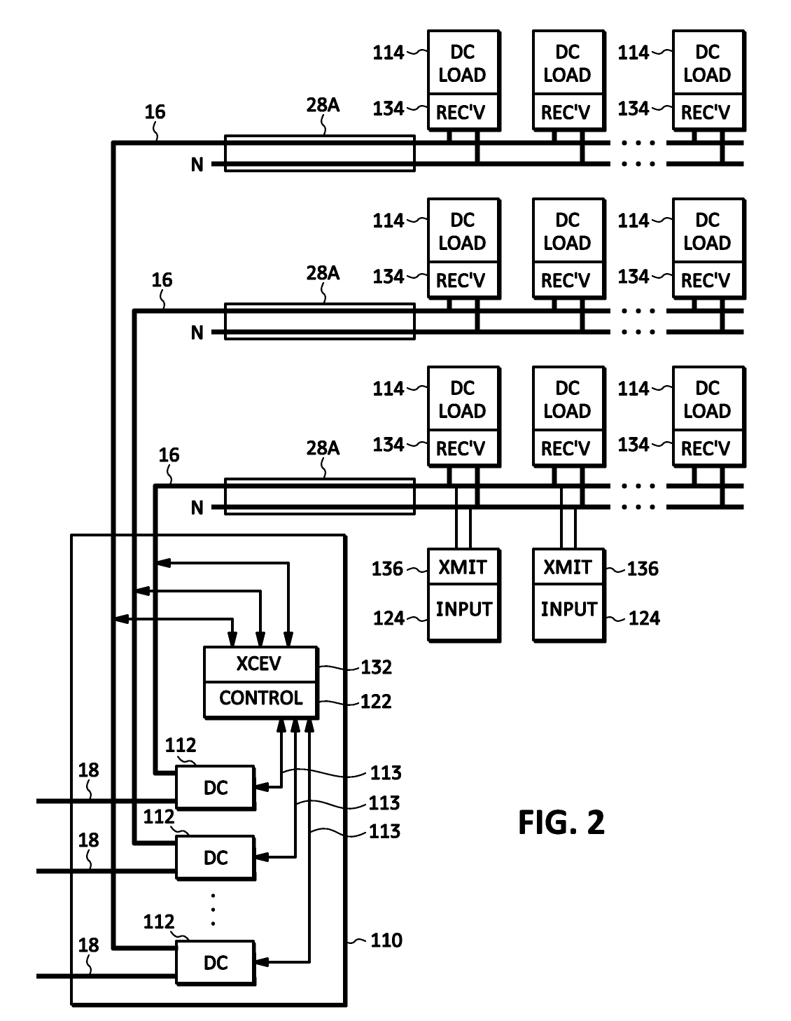

FIG. 2 illustrates an example embodiment of a lighting control system and installation method according to some inventive principles of this patent disclosure. A power distribution unit, which in this embodiment is implemented as a power supply cabinet 110, includes individual DC power supplies 112 that supply power to one or more DC loads 114 through building power wiring 28A. The power distribution unit may also be implemented as any other type of enclosure, panel, housing, etc.

The inputs 18 to the DC power supplies 112 may be AC power from a conventional circuit breaker panel or any other AC power source. Alternatively, the DC power supplies 112 may receive DC power from one or more photovoltaic (PV) panels, battery banks, etc. Although the embodiment of FIG. 2 is illustrated with individual inputs 18 for each DC power supply 112, a single power input may be distributed to multiple DC power supplies 112 through a bus bar or other arrangement. Moreover, one or more circuit breakers or other overcurrent protection devices may be included integrally in the power supply cabinet 110 to provide overcurrent protection to one or more of the DC power supplies 112 and circuits and/or feed wiring to the cabinet.

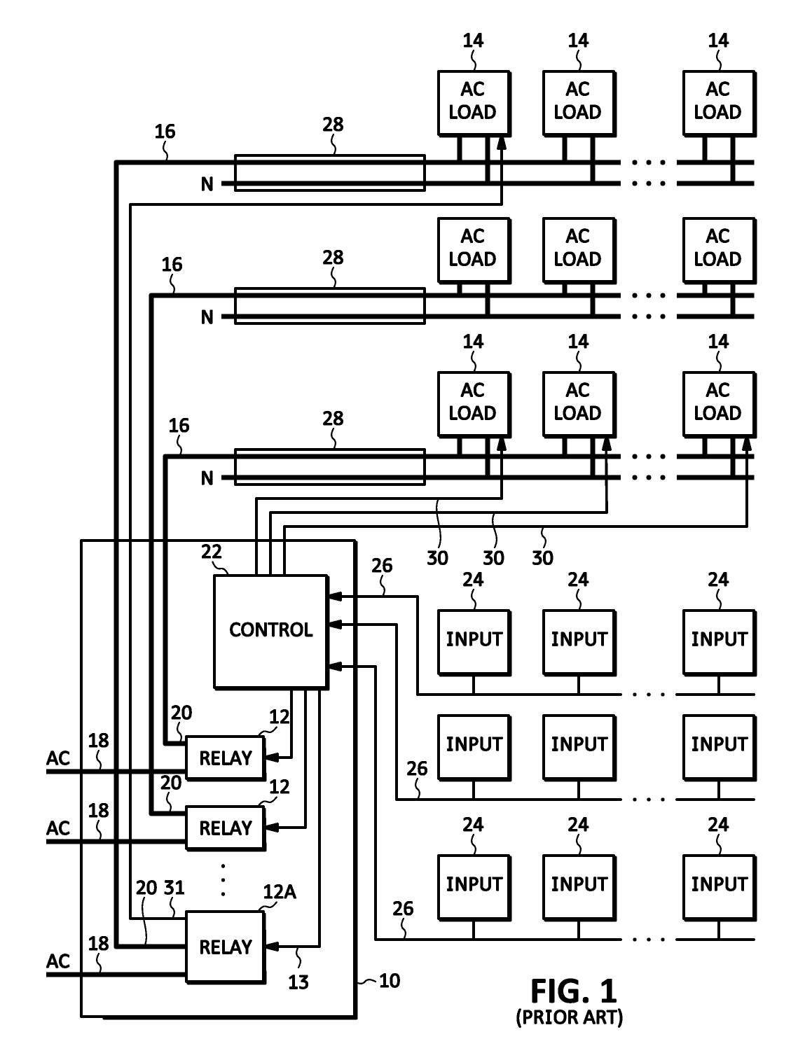

In some embodiments, a DC power distribution system according to the inventive principles of this patent disclosure may utilize control wiring that is separate from the building power wiring. For example, an embodiment that includes DC power supplies 112 and DC loads 114 as shown in FIG. 2 may continue to use separate control wiring such as wiring 26 and 30 as shown in FIG. 1.

In the embodiment of FIG. 2, however, some or all of the control functionality is implemented by modulating one or more control signals onto the DC power conductors. Thus, the controller 122 includes a transceiver 132 that enables the controller to transmit and/or receive control signals to and/or from one or more DC loads 114, input devices 124 and/or other devices that are connected to the building power wiring 28A that carries the DC power from the DC power supplies 112 to the DC loads 114.

For example, one of the DC loads 114 may be implemented as a dimmable fluorescent ballast having a receiver 134. The controller 122 may send a dimming level control signal to the ballast by modulating the control signal onto the DC power conductor 16 using transceiver 132. The receiver 134 then demodulates the control signal from the DC power conductor and dims its load accordingly in response to the dimming level control signal, while continuing to receive DC power through the DC power conductor 16.

As another example, an input device 124 such as a digital switch, occupancy sensor, photocell, etc., may be coupled to the building power wiring through a transmitter 136 that modulates an input signal such as a dimming level command, occupancy information, ambient light level, etc., onto the power conductor 16. The input signal may then be demodulated by the transceiver 132 and utilized by the controller 122 in the same manner as if the control signal had been received through separate wiring.

In the example of FIG. 2, the transmitters, receivers and transceivers are shown integral with their respective input devices, loads and controllers. In other embodiments, however, any or all of the transmitters, receivers and transceivers may be realized as separated components such as converter modules that may interface existing input devices, loads and controllers to a DC power bus with modulated control signals according to the inventive principles of this patent disclosure.

In the example of FIG. 2, the DC power supplies 112 are shown having individual communication links 113 to the controller 122, but in other embodiments, the power supplies may be interfaced to the controller through a network using any suitable networking technology such as any of those known as Control Area Network (CAN), LonWorks, Modbus, etc.

Although the embodiment of FIG. 2 is shown with bi-directional communication over the DC buses created on the building power wiring 28A, other embodiments may be implemented according to some inventive principles in which control signals may be modulated on the DC buses in one direction only, or in different directions on different buses, or hybrid systems may be implemented with any suitable combination of conventional separate control wiring and modulated control signals. Moreover, in some embodiments, communications between the controller 122 and input devices may be bi-directional to enable an input device to function as a display or remote controller. Likewise, communications between the controller 122 and loads may be bi-directional to enable a load to report status or fault information, operate as an input, etc.

Some additional inventive principles relate to converting an AC power distribution system to a DC power distribution system while utilizing some or all of the existing building power wiring. For example, one or more of the AC lighting loads shown in FIG. 1 are disconnected from the building power wiring 28 and replaced with one or more DC loads 114. The relay cabinet 10 is replaced with a power supply cabinet 110 that includes the individual DC power supplies 112. Thus, the relays 12 shown in FIG. 1 are disconnected from the building power wiring 28 and replaced with one or more DC power supplies 112. The building power wiring 28 shown in FIG. 1 may then be utilized as the building power wiring 28A shown in FIG. 2.

Depending on the implementation details, DC power methods and apparatus described above with respect to FIG. 2 may provide several advantages and benefits. For example, in existing AC lighting systems, electronic ballasts convert AC power into DC power as an intermediate step, then use lamp drivers to convert the DC power back to high-frequency AC power to drive fluorescent lamps or other light sources. In an embodiment as described above, however, DC power may be supplied directly to the lamp drivers, thereby eliminating the AC to DC converter in each ballast which, in turn, may reduce the cost of each ballast, improve the reliability of each ballast, improve the energy distribution efficiency of the system and/or reduce the cost of operation.

As another example, the inventive principles may enable the elimination of some or all of the separate control wiring between the controller and the loads and input devices. By modulating data on the DC power conductors, a single pair of conductors may be used to provide all power and data distribution for any loads and input devices that may be connected to an entire lighting circuit, thereby eliminating the need for additional wiring.

The inventive principles may be especially beneficial in retrofit installations where the installation time and cost of materials and labor may be greatly reduced by utilizing existing building power wiring. For example, in legacy relay systems with simple on/off control of ballasts and other AC loads, only building power wiring is run between the relay cabinet and the loads. If additional functionality such as dimming, daylight harvesting, etc. is required, then separate pairs of control wires are required to network the devices in the system. According to the inventive principles, however, ballasts, sensors, switches, etc., may be connected to a single pair of DC bus wires with no additional wires being required.

AC power line communications (PLC) may be used to modulate control signals onto an AC power conductor, but AC PLC technology tends to be expensive and typically does not work well with electronic power supplies/ballasts which inject harmonics onto the conductors. With a DC bus, however, the modulation is less complex and therefore modulating control signals onto the DC power conductors may be less expensive and/or more reliable.

Thus, the inventive principles of this patent disclosure may enable the building power wiring to be used for communications as well as power distribution, thereby reducing the cost of providing additional functionality to the system.

Building power wiring refers to wiring, typically premises wiring according to the National Electrical Code (NEC), that is capable of carrying substantial power such as for electric lighting and power circuits, as opposed to wiring that has conventionally been used only for remote-control and signaling circuits. Thus, for example, building power wiring does not include Class-2 wiring under the NEC.

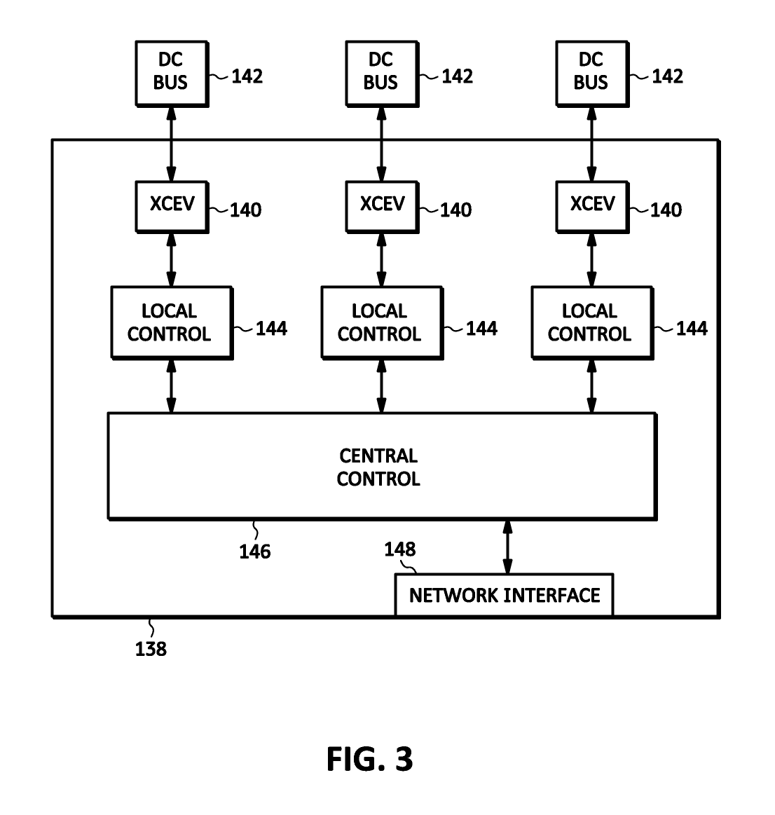

FIG. 3 illustrates an embodiment of a control module for a DC power distribution system according to some inventive principles of this patent disclosure. The embodiment of FIG. 3 may be used to implement, for example, the controller 122 and transceiver 132 of FIG. 2, but the inventive principles are not limited to that particular application.

Referring to FIG. 3, the control module 138 includes multiple transceivers 140, each of which is connected to a corresponding DC power bus 142. Each transceiver 140 may modulate data signals onto, and demodulate data signals from, its corresponding DC power bus. Associated with each transceiver is local control functionality 144 which processes network data traffic to and/or from each device connected to the corresponding DC power bus. For example, a specific DC power bus may be powered by a DC power supply and be connected through building power wiring to three DC ballasts, each having a receiver for receiving dimming level commands, an occupancy sensor having a transmitter, a photocell having a transmitter, and a digital switch/display having a transceiver. The local control functionality 144 for that specific DC power bus may be configured to control the three DC ballasts in response to the digital switch, occupancy sensor and photocell. The local control functionality may also be configured to display status, fault or other information relating to devices connected to that specific DC power bus on the digital switch/display.

The embodiment of FIG. 3 also includes central control functionality 146 which may control system wide functions. For example, the entire system may operate on a central timer and/or calendar schedule that applies to all devices on all DC power buses. Other possible examples of central control functions may include programming the local control functionality, monitoring device status, load shedding in response to utility demand response signals, configuring reconfigurable DC power sources as described below, inrush current control as described below, etc. Alternatively, the control functionality may be divided between the local control functionality 144 and central control functionality 146 in other ways. For example, different DC power buses may be configured to operate based on different timer/calendar functions.

The control module 138 of FIG. 3 may also include one or more network interfaces 148 to interconnect multiple control modules in one or more power supply cabinets. Any suitable networking technology may be used including wired networks such as Ethernet, and/or any of the spread-spectrum wireless technologies such as those known as Wi-Fi, Bluetooth, etc.

Any of the transceiver and control functionality illustrated in the embodiment of FIG. 3 may be implemented in analog and/or digital hardware, software, firmware or any suitable combination thereof. For example, in some embodiments, separate micro-controllers may be used to implement each of the local control functions 144 as well as the central control functionality, while in other embodiments, a single microcontroller may be used with separate software modules or routines being used to implement each of the local and central control functions.

The control module 138 is illustrated as a single module, but the functions may be distributed among various components. For example, the transceiver 140 and local control functionality 144 may be integrated into the corresponding DC power supply for each DC bus. In some embodiments, the transceiver 140 may only be a unidirectional device, i.e., a transmitter or receiver.

Depending on the implementation details, the inventive principles relating to modulating control data over a DC power bus as illustrated above with respect to FIGS. 2 and 3 may provide various advantages and benefits. For example, confining any control functions and communication to the network of devices connected to a specific DC power bus may reduce network traffic. It may also simplify the system programming and/or configuration process.

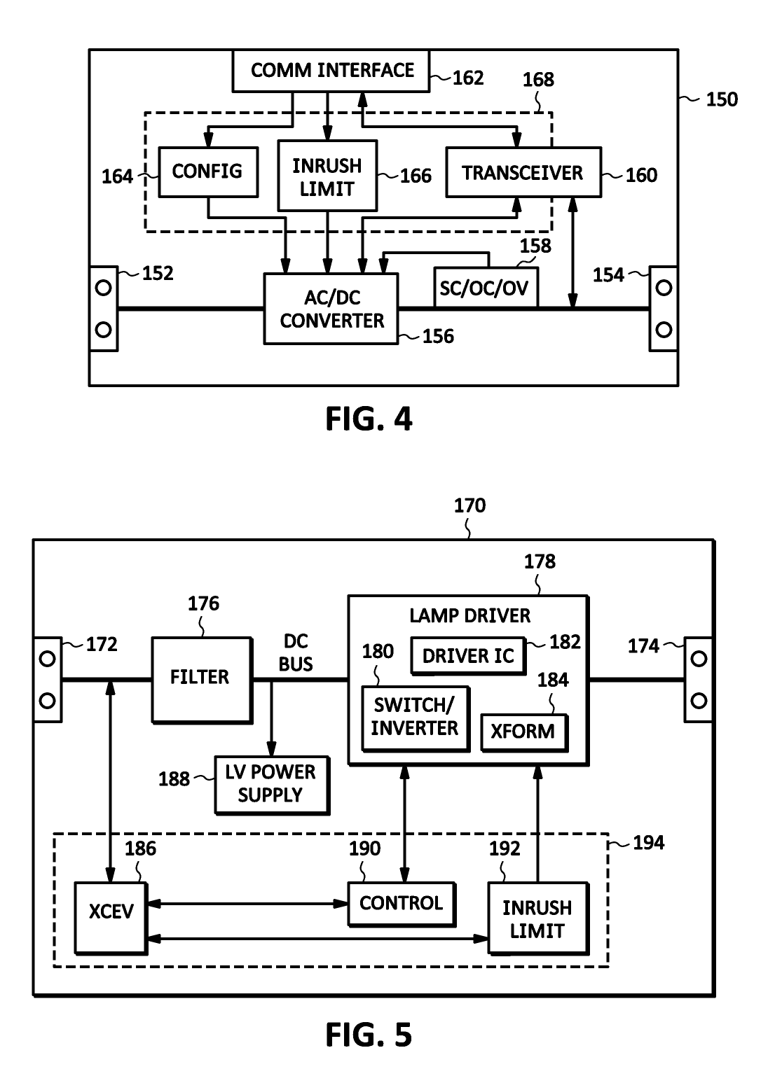

FIG. 4 illustrates an embodiment of a DC power supply for a DC power distribution system according to some inventive principles of this patent disclosure. The embodiment of FIG. 4 may be used to implement, for example, any of the DC power supplies 112 of FIG. 2, but the inventive principles are not limited to that particular application.

The DC power supply 150 of FIG. 4 includes one or more input terminals 152 and one or more output terminals 154 for making connections to line and load conductors, respectively. In this embodiment, an AC to DC converter 156 converts AC input power to a fixed or variable DC bus voltage at any suitable voltage and/or current levels. In other embodiments, a DC to DC converter may be used to distribute power from an alternative energy source or other source of DC power.

A short circuit and/or overcurrent and/or overvoltage sensor 158 may be included to limit the output of the AC to DC converter to prevent damage to the power supply and/or corresponding DC power bus. The power supply may include a transceiver 160 to enable communications directly with any devices on the DC power bus. A communication interface 162 enables the power supply to communicate with a local or central controller. If the power supply includes a transceiver 160, communications to/from the DC bus may be relayed to/from a central or local controller through the communication interface 162. Alternatively, the transceiver 160 may be omitted and the power supply may communicate only through the communication interface 162.

Configuration functionality 164 may be included to enable the power supply 150 to be configured locally or remotely, e.g. by receiving configuration commands through the communication interface 162 or transceiver 160. If the AC to DC converter 156 is capable of providing a variable output voltage and/or current, the configuration functionality may be used to set the output level in response to configuration commands from a local or central controller depending on the type of load or loads that are present on the DC bus. For example, a higher voltage on the order of 400 VDC may be supplied for server power supply applications, whereas a lower voltage on the order of 100 VDC or less may be supplied for lighting loads such as light emitting diode (LED) lighting or DC fluorescent ballasts. Alternatively, if the AC to DC converter 156 is only capable of providing a fixed output voltage and/or current, the configuration functionality may simply notify a local or central controller of the voltage and/or current output of the power supply. A local input device such as a DIP switch may be included to provide a local input for configuring the power supply.

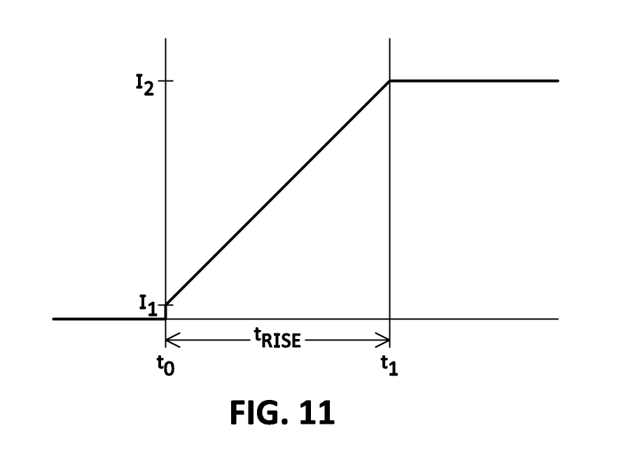

Inrush limiting functionality 166 may be included to reduce the inrush current to ballasts and/or other loads on the DC power bus during start-up. For example, on a local level, when the power supply is switched on, it may gradually ramp up the output voltage, and therefore, the inrush current drawn by lighting ballasts or other loads may start at a low level and ramp up gradually. Any or all of the parameters relating to inrush limiting may be made configurable according to the inventive principles of this patent disclosure. Referring to FIG. 11, configurable parameters include the initial current I₁, the final current I₂, the rise time t_{RISE}, the slope or ramp rate, which is given by (I₂-I₁)/t_{RISE}, etc. For example, the inrush limiting functionality may be configured for a fixed ramp rate with an initial current I₁ of zero. In this example, when a load is turned on, the current begins at zero, then steadily ramps up at the programmed ramp rate until the load reaches its final value, regardless of what that value is. Thus, the rise time t_{RISE} is may not be known in advance, but depends on the ramp rate and whatever final value of load current the load draws.

Alternative or additional inrush limiting functionality may be provided by programming, configuring or controlling different ballasts or other loads on the DC power bus to start at various times to prevent a large surge current that would otherwise occur if all of the loads start at the same time. On a system-wide level, additional or alternative inrush limiting functionality may be provided by programming, configuring or controlling different DC power supplies to turn on at various times to spread the inrush current over a longer time. System-wide inrush limiting functionality may be provided by central control such as functionality 146 as shown in FIG. 3, whereas inrush limiting functionality at a local level may be provided by local control functionality 144 as shown in FIG. 3 and/or inrush limiting functionality 166 in individual power supplies as shown in FIG. 4.

The configuration functionality 164, inrush limiting functionality 166, transceiver 160 and any other control functionality may be implemented with analog and/or digital hardware, software, firmware or any suitable combination thereof. For example, in some embodiments, a microcontroller 168 may be used to implement all of the configuration functionality 164, inrush limiting functionality 166, and most of the transceiver 160 with the exception of an analog front end to perform the modulation and/or demodulation functions.

In some embodiments, only fixed output DC power supplies may be used, and thus, the only configurability may be achieved by installing DC power supplies having different fixed outputs. In other embodiments, some or all of the DC power supplies may have variable outputs. In some embodiments, the DC power supplies may be designed as modules that may be removed and installed by an installer or end user, whereas, in other embodiments, some or all of the power supplies may be permanently installed at the factory. The DC power supplies may be sized to match commonly available circuit breakers.

FIG. 5 illustrates an embodiment of a ballast for a DC power distribution system according to some inventive principles of this patent disclosure. The embodiment of FIG. 5 may be used to implement, for example, any of the DC loads 114 of FIG. 2, but the inventive principles are not limited to that particular application.

The ballast 170 includes one or more input terminals 172 and one or more output terminals 174 for making connections to the DC power bus and one or more lamps, respectively. A filter 176 suppresses harmonics that may otherwise be injected back into the DC power bus by a lamp driver 178. The lamp driver includes one or more power switches and an inverter 180 that convert the DC bus power to high-frequency AC power suitable for driving a fluorescent lamp or other gas discharge lamp. The one or more power switches may be controlled by a commercially available lamp driver integrated circuit (IC) 182. Depending on the number of lamps, required operating voltage, etc., a transformer 184 may be included to form part of a resonant inverter circuit and to transform the high-frequency AC voltage to a value that is suitable for driving the lamp or lamps.

The ballast 170 shown in FIG. 5 also includes a transceiver 186 to enable the ballast to communicate over the DC power bus. Control functionality 190 provides overall control of the ballast, while inrush limiting functionality 192 provides any or all of the local current inrush limiting functionality discussed above. A low-voltage (control) power supply 188 converts DC power from the DC power bus to a form, typically at a lower voltage, that is suitable for use by the control circuitry in the ballast.

The control functionality 190, inrush limiting functionality 192, transceiver 186 and any other control functionality may be implemented with analog and/or digital hardware, software, firmware or any suitable combination thereof. For example, in some embodiments, a microcontroller 194 may be used to implement all of the control functionality 190, inrush limiting functionality 192, and most of the transceiver 186 with the exception of an analog front end to perform the modulation and/or demodulation functions.

The control functionality 190 may include any suitable amount of intelligence depending on the system configuration and control strategy. For example, in some embodiments, the control functionality 190 may include minimal intelligence so the ballast simply responds to control commands sent by the central or local control functionality described above in the context of FIGS. 3 and 4. In other embodiments, the control functionality 190 may include more intelligence to enable the ballast to implement more advanced control algorithms, for example, directly in response to input devices such as occupancy sensors, photocells, digital switches, etc., without intervention from other system components.

Depending on the implementation details, the inventive principles relating to DC ballasts and other types of DC loads may provide various advantages and benefits. For example, a conventional AC ballast includes an AC/DC converter section to generate a high-voltage DC link, followed by a DC/AC inverter to drive a lamp. Because of the high DC link voltage, the power semiconductor switches in the inverter must operate at high voltages which increases the cost and reduces the reliability of the switches. The presence of high DC voltages on circuit boards also necessitates the use of proper component clearance which takes up valuable circuit board space.

In contrast, a DC power distribution system according to the inventive principles of this patent disclosure may enable a ballast or other load to use a single power stage, e.g., just a lamp driver, which may improve efficiency. Moreover, a DC ballast may be able to operate at lower voltages, thereby eliminating the need for high voltage semiconductor components and high voltage component clearance on circuit boards and elsewhere in the ballast. Thus, the ballast may be simpler and more compact, thereby reducing the size and/or cost of the ballast.

Some of the inventive principles described above and below may be combined in synergistic ways according to some additional inventive principles of this patent disclosure. For example, if the AC to DC converter 156 shown in FIG. 4 is capable of providing a variable output voltage and/or current, the configuration functionality may be used to set the DC bus voltage to an optimum value that is slightly higher than the value required by a corresponding load such as the ballast shown in FIG. 5. In embodiments in which the power supply 150 provides power to more than one load, the value may be set to an optimum value that is slightly higher than the value required by the load that requires the highest input voltage or current.

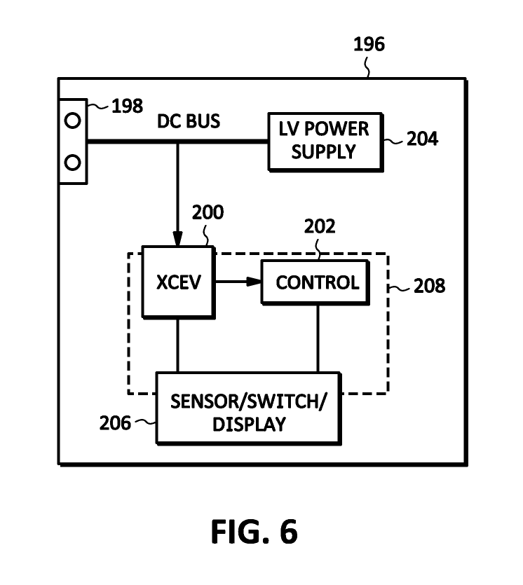

FIG. 6 illustrates an embodiment of an input/display device for a DC power distribution system according to some inventive principles of this patent disclosure. The embodiment of FIG. 6 may be used to implement, for example, any of the input devices 124 of FIG. 2, but the inventive principles are not limited to that particular application.

The input/display device 196 shown in FIG. 6 includes one or more input terminals 198 for connecting the device to the DC power bus. A transceiver 200 enables the device to communicate over the DC power bus. Control functionality 202 provides overall control of the device. A low-voltage (control) power supply 204 converts DC power from the DC power bus to a form, typically at a lower voltage, that is suitable for use by the control circuitry in the device.

Sensor/switch/display functionality 206 may include any type of input/display functionality such as occupancy sensors, photocells, pushbutton switches, toggle switches, keypads, alphanumeric LCD displays, LED indicator lights, bar graph displays, analog inputs, etc.

The control functionality 202, transceiver 200 and any other control, input or display functionality may be implemented with analog and/or digital hardware, software, firmware or any suitable combination thereof. For example, in some embodiments, a microcontroller 208 may be used to implement all of the control functionality 202, most of the transceiver 200, with the exception of an analog front end to perform the modulation and/or demodulation functions, and any suitable portion of the sensor/switch/display functionality 206.

The control functionality 202 may include any suitable amount of intelligence depending on the system configuration and control strategy. For example, in some embodiments, the control functionality 202 may include minimal intelligence so that basic inputs such as button presses are simply communicated to central or local control functionality described above in the context of FIGS. 3 and 4. In other embodiments, the control functionality 202 may include more intelligence to enable the device to implement more advanced control algorithms, for example, by directly controlling the output of a dimming ballast in response to input devices such as occupancy sensors, photocells, digital switches, etc., without intervention from other system components.

In some embodiments, the sensor/switch/display functionality 206 may be implemented as a programming unit that provides a user interface (UI) for programming and configuration of the system or any components of the system. The programming unit may be separate from or integral with the input/display device 196. For example, the input/display device 196 may be located at any suitable point in the system serve only as an attachment point for a hand-held programming unit. Alternatively, the device 196 may be implemented as an input/output device, but with an additional interface for connection to a hand-held programming unit.

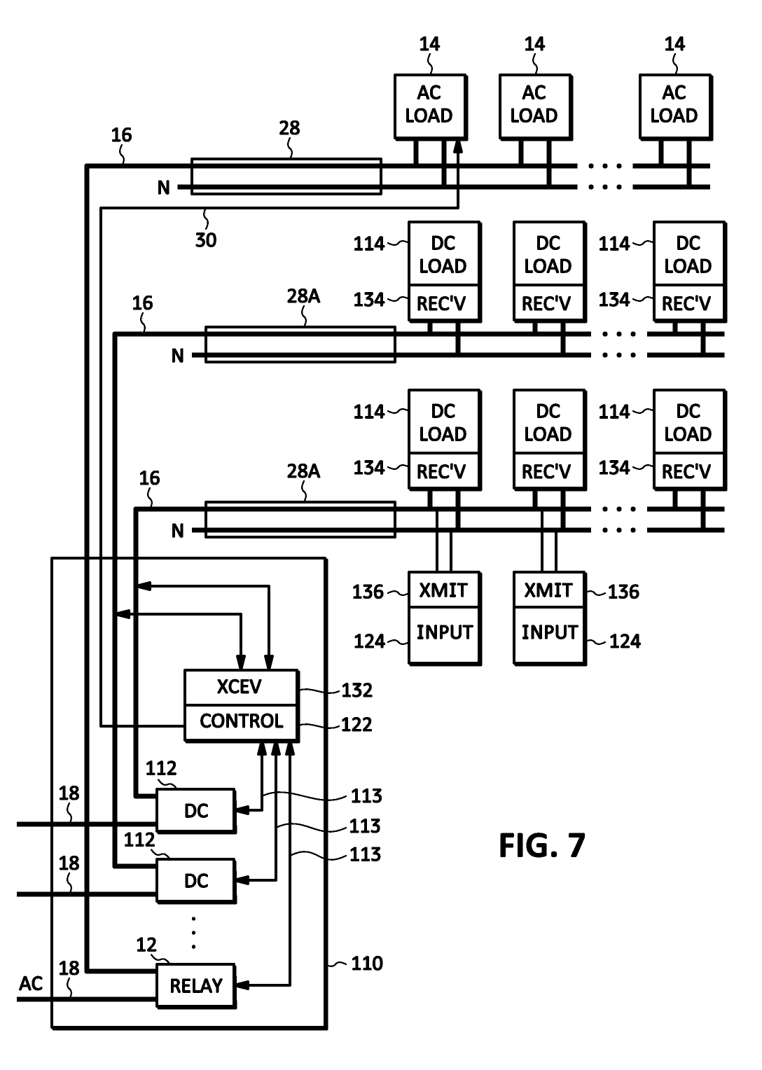

FIG. 7 illustrates another embodiment of a power distribution and control system according to some inventive principles of this patent disclosure. The embodiment of FIG. 7 includes most of the same components as the embodiment of FIG. 2, but also combines one or more AC relays 12 in a single cabinet with the DC power supplies 112. Thus, the cabinet 110 may provide and control power to one or more AC loads 14 in addition to the DC loads 114. If any of the AC loads 14 are capable of local control, signal wiring 30 may be run between the controller 122 and one or more of the loads, or through one or more of the AC relays 12. Alternatively, control signals may be provided to one or more of the AC loads through building wiring 16 using AC power line communications through transceiver 132 provided the AC load is provided with a corresponding receiver or transceiver.

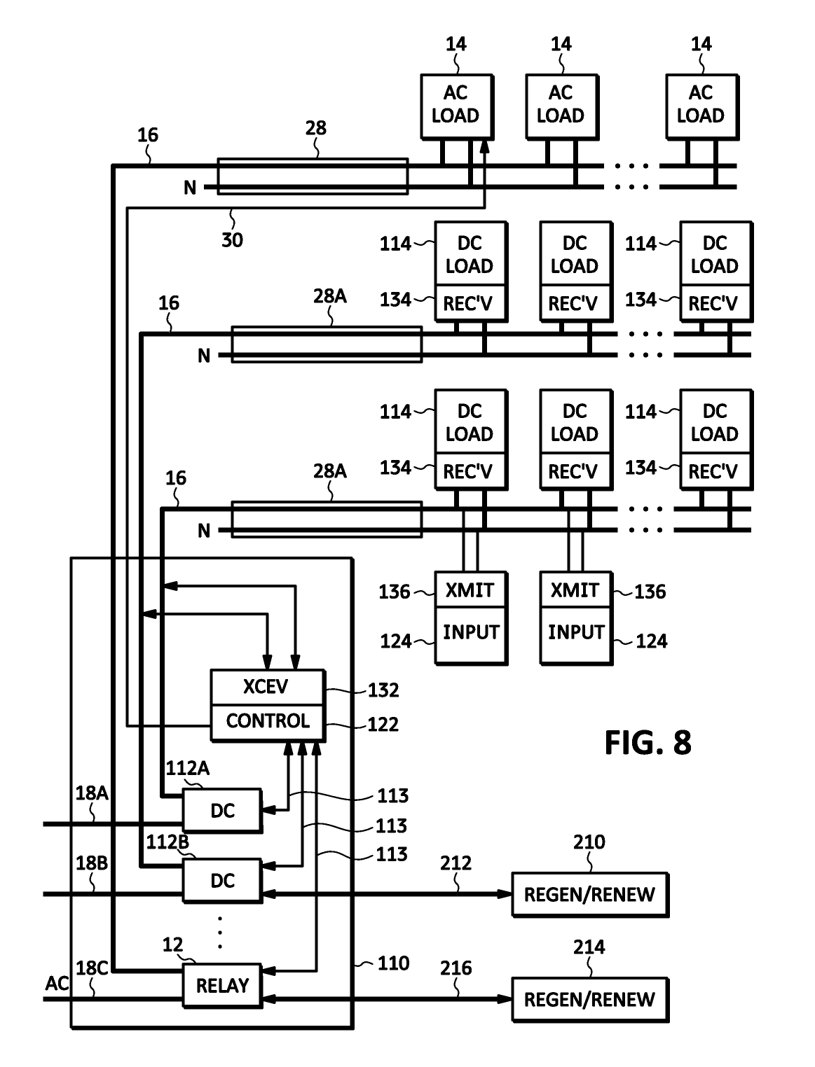

FIG. 8 illustrates another embodiment of a power distribution and control system according to some inventive principles of this patent disclosure. The embodiment of FIG. 8 includes essentially the same features as the embodiment of FIG. 7, but with the addition of functionality to accommodate regenerative/renewable power components 210 and 214. Examples of these power components include rechargeable batteries, motors with regenerative braking, flywheels, photovoltaic (PV) panels, fuel cells, wind turbine, etc.

Regenerative/renewable power component 210 is shown coupled to DC supply 112B through a bi-directional DC connection 212, but depending on the nature of the power component, power may only flow in one direction, and the input 18B to the DC supply may or may not be included. For example, if the power component 210 is implemented as a rechargeable battery, the input 18B DC supply 112B may be included to provide power to the corresponding loads 114 as well as to charge the battery at times when adequate power is available. At other times, power from the battery may flow back into the DC supply 112B and to the corresponding loads 114 and/or back out through the input connection 18B. As another example, if the power component 210 is implemented as a PV panel, power may only flow from the PV panel into the DC supply 112B and into the corresponding loads 114 and/or out through the input 18B, depending on the amount of power available.

Similarly, regenerative/renewable power component 214 is shown coupled to relay 12 through a bi-directional AC connection 216, but depending on the nature of the power component, power may only flow in one direction, and the input 18C to the relay may or may not be included. For example, if the power component 214 is implemented as a PV panel with an inverter to convert the DC power from the panel to AC, the PV panel may generate enough power during periods of peak sunlight to supply the loads 114 and also push any excess power back into a local utility grid through input connection 18C. As the power available from the PV panel decreases, the corresponding loads 114 may need to draw an increasing amount of power from the grid.

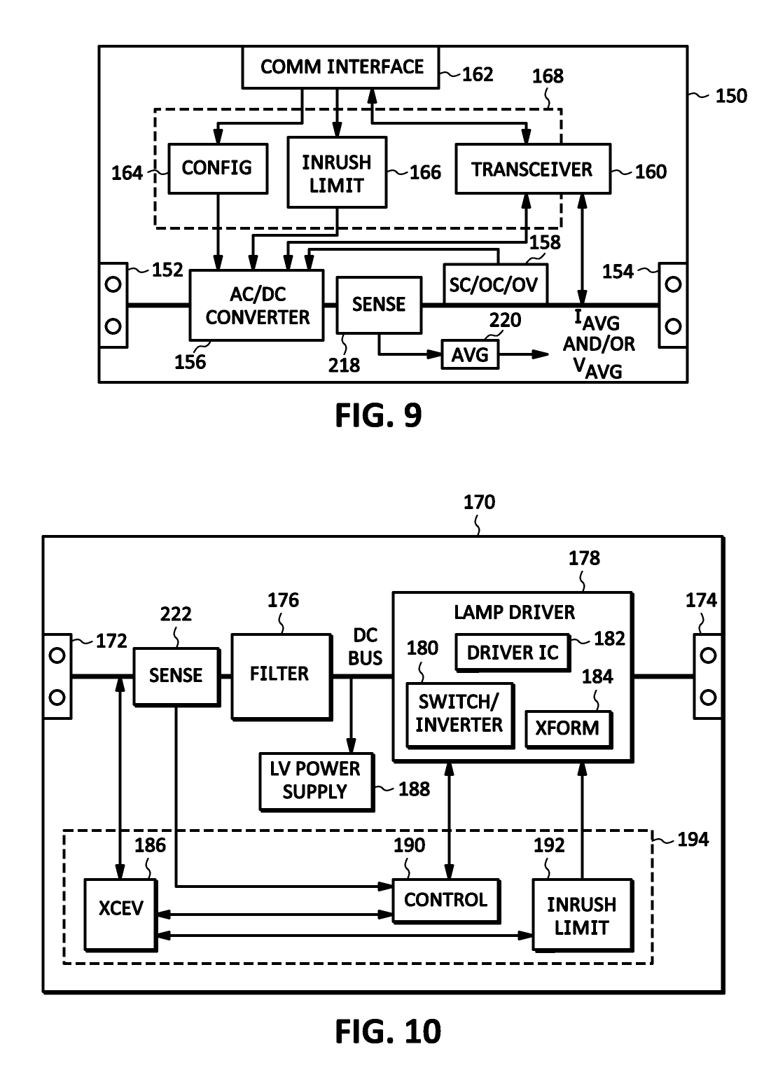

FIG. 9 illustrates another embodiment of a DC power supply for a DC power distribution system according to some inventive principles of this patent disclosure. The embodiment of FIG. 9 includes essentially the same features as the embodiment of FIG. 4, but with the addition of branch circuit monitoring functionality. A sense circuit 218 senses the output voltage and/or current of the DC power supply. An averaging circuit 220 averages the output from the sense circuit to generate I_{AVG} and/or V_{AVG} signals indicative of the average output voltage and/or current from the power supply. Although shown as a separate component, the functions of averaging circuit 220 may be performed by other circuitry within or outside of the power supply. For example, the averaging functions may be performed by the microcontroller 168. Moreover, additional metrics such as peak values, root-mean-square (RMS), etc., may be extracted from the signals generated by the sense circuit. For example, the power may be calculated by multiplying the average DC voltage and DC current. The power or other metrics may be transmitted from the DC power supply or other power distribution unit to a control module such as that shown in FIG. 3. The data may then be further transmitted to a user interface or other device through the network interface 148.

FIG. 10 illustrates another embodiment of a ballast for a DC power distribution system according to some inventive principles of this patent disclosure. The embodiment of FIG. 10 includes essentially the same features as the embodiment of FIG. 5, but with the addition of branch circuit monitoring functionality similar to that shown in the embodiment FIG. 9. Referring to FIG. 10, a sense circuit 222 senses the input voltage and/or current of the ballast. The output from the sense circuit is processed by the controller 190 to extract metrics such as average value, RMS, peak values, etc. As with the DC power supply of FIG. 9, the ballast of FIG. 10 may calculate power, and the power or other metrics may be transmitted from the ballast to a control module, and from the control module the data may then be further transmitted to a user interface or other device.

Sensing functionality according to the inventive principles of this patent disclosure such as that illustrated in the context of FIGS. 9 and 10 may provide numerous benefits. By implementing both current and voltage sensing, various measures of the power consumption may be monitored. For example, by calculating the average current and average voltage, the average power consumption may be obtained through a straightforward multiplication operation. Measuring power and other parameters in a DC form such as shown in FIGS. 9 and 10 may provide a simpler, more reliable, and/or less expensive solution than measurements in AC form because DC values of current, voltage, etc., even with harmonics imposed, are typically easier to monitor than AC values.

The measurement and calculation functionality enabled by the inventive principles of this patent disclosure may be especially beneficial in the context of energy usage monitoring systems. For example, the methods and apparatus described according to the inventive principles of this patent disclosure may be utilized to provide convenient data harvesting for building energy management systems.

Additional embodiments according to some inventive principles of this patent disclosure are as follows.

A power distribution unit may include: one or more first terminals to connect the unit to a building power wiring line circuit; one or more second terminals to connect the unit to a building power wiring load circuit; a power supply coupled between the first terminals and the second terminals to convert power from the building power wiring line circuit to DC power for the building power wiring load circuit; and a transmitter adapted to modulate a data signal on the DC power.

The transmitter may be integral with the power supply. The unit may further include a control module arranged to control the power supply. The transmitter may be integral with the control module. The unit may further include a receiver adapted to receive a data signal modulated on the DC power. The transmitter and receiver may form an integral transceiver. The power supply may be configurable. The power supply may be configured by replacing the power supply. The power supply may be configured by receiving a configuration command. The power supply may be configured in response to the type of load coupled to the power supply.

A method may include: disconnecting a building power wiring load circuit from a relay; disconnecting an AC load from the building power wiring load circuit; connecting a DC power supply to the building power wiring load circuit; and connecting a DC load to the building power wiring load circuit.

The method may further include coupling a transmitter to the building power wiring load circuit to modulate a data signal on the building power wiring load circuit. The DC load may include a receiver adapted to receive the data signal. The DC load may include a ballast; and the data signal may include dimming level information for the ballast. The DC power supply and the transmitter may be located at a power distribution unit. The DC power supply may be located at a power distribution unit; and the transmitter may be coupled to the building power wiring load circuit at a location remote from the power distribution unit. The transmitter may be integral with an input device. The input device may include a switch. The input device may include an occupancy sensor. The input device may include a photocell.

A power distribution unit may include: a first DC power supply adapted to provide a first DC power bus on a first building power wiring load circuit; a second DC power supply adapted to provide a second DC power bus on a second building power wiring load circuit; a first transceiver arranged to modulate data on the first DC power bus; a second transceiver arranged to modulate data on the second DC power bus; a controller arranged to provide central control functions to the power distribution unit.

The unit may further include first local control functionality adapted to process data traffic on the first DC power bus; and second local control functionality adapted to process data traffic on the second DC power bus. Communications relating to local control functions may be substantially confined to the DC power buses. The central control functions may include configuration functions. The central control functions may include monitoring the status of devices connected to the DC power buses. The central control functions may include inrush limiting functionality.

A DC power supply may include: one or more first terminals to receive input power; one or more second terminals to couple the power supply to a DC power bus; a power converter to convert the input power to DC power for the DC power bus; and a transmitter adapted to modulate a data signal on the DC power.

The power supply may further include a receiver adapted to receive a data signal modulated on the DC power. The transmitter and receiver may form an integral transceiver. The power supply may further include inrush limiting functionality coupled to the power converter. The power converter may be configurable. The power supply may further include configuration functionality coupled to the power converter. The power supply may further include monitoring functionality to monitor the power supplied to the DC power bus. The load circuit monitoring functionality may be adapted to transmit one or more metrics of the DC power bus through the transmitter. The load circuit monitoring functionality may be adapted to calculate the power supplied to the DC power bus.

An apparatus may include: one or more first terminals to receive DC power from a DC power bus; a load driver coupled to the first terminals to receive the DC power; and a receiver adapted to receive data modulated on the DC power.

The apparatus may further include a transmitter adapted to modulate data on the DC power. The transmitter and receiver may form an integral transceiver. The apparatus may further include inrush limiting functionality coupled to the load driver. The apparatus may further include one or more second terminals to couple the load driver to a load. The apparatus may include a ballast; and the load driver may include a lamp driver. The load driver may include a variable speed fan driver.

An apparatus may include: one or more first terminals to connect the apparatus to a building power wiring load circuit; an input device; a transmitter adapted to modulate a data signal on DC power on the building power wiring load circuit; a power supply adapted to convert DC power from the building power wiring load circuit to a form usable by the input device and the transmitter.

The input device may include a switch. The input device may include an occupancy sensor. The input device may include a photocell.

A power distribution unit may include: one or more first terminals to connect the unit to a building power wiring line circuit; one or more second terminals to connect the unit to a building power wiring load circuit; and a power supply coupled between the first terminals and the second terminals to convert power from the building power wiring line circuit to DC power for the building power wiring load circuit; where the power supply includes inrush limiting functionality having one or more configurable parameters.

The one or more configurable parameters may include a ramp rate. The one or more configurable parameters may include a rise time. The one or more configurable parameters may include an initial value.

A power distribution unit may include: a DC power supply adapted to provide a DC power bus on a first building power wiring load circuit; a relay adapted provide AC power on a second building power wiring load circuit; and a controller arranged to provide central control functions to the power distribution unit.

The DC power supply may be capable of bi-directional power flow. The relay may be capable of bi-directional power flow.

A power distribution unit may include: a first DC power supply adapted to provide a first DC power bus on a first building power wiring load circuit; a second DC power supply adapted provide a second DC power bus on a second building power wiring load circuit; and a controller arranged to provide central control functions to the power distribution unit; where the first DC power supply is capable of bi-directional power flow.

The first DC power supply may include a connection for a regenerative power component. The first DC power supply may be capable of outputting power through a power input connection.

The inventive principles of this patent disclosure have been described above with reference to some specific example embodiments, but these embodiments can be modified in arrangement and detail without departing from the inventive concepts. For example, some embodiments have been described in the context of lighting loads, but the inventive principles also apply to fans, shades, and other electrical loads. As another example, any number of DC power supplies may be included in a power supply cabinet, and any number of power supply cabinets may be networked together in an installation. As a further example, terminals may take any suitable form including screw terminals, spring-loaded terminals, wire leads, etc. Thus, any changes and modifications are considered to fall within the scope of the following claims.

1. A power distribution unit comprising:
one or more first terminals to connect the unit to a building power wiring line circuit;
one or more second terminals to connect the unit to a building power wiring load circuit;
a power supply coupled between the first terminals and the second terminals to convert power from the building power wiring line circuit to DC power for the building power wiring load circuit; and
a transmitter adapted to modulate a data signal on the DC power.

2. The power distribution unit of claim 1 where the transmitter is integral with the power supply.

3. The power distribution unit of claim 1 further comprising a control module arranged to control the power supply.

4. The power distribution unit of claim 3 where the transmitter is integral with the control module.

5. The power distribution unit of claim 1 where the power supply is configurable.

6. The power distribution unit of claim 5 where the power supply may be configured by replacing the power supply.

7. The power distribution unit of claim 5 where the power supply may be configured by receiving a configuration command.

8. The power distribution unit of claim 5 where the power supply may be configured in response to the type of load coupled to the power supply.

9. The power distribution unit of claim 1 further comprising:
a relay adapted to provide AC power to a second building power wiring load circuit; and
a controller arranged to provide central control functions to the power distribution unit.

10. The power distribution unit of claim 1 further comprising:
a second power supply adapted to provide DC power to a second building power wiring load circuit; and
a controller arranged to provide central control functions to the power distribution unit;
where the first power supply is capable of bi-directional power flow.

11. A method comprising:
disconnecting a building power wiring load circuit from a relay;
disconnecting an AC load from the building power wiring load circuit;
connecting a DC power supply to the building power wiring load circuit; and
connecting a DC load to the building power wiring load circuit.

12. The method of claim 11 further comprising coupling a transmitter to the building power wiring load circuit to modulate a data signal on the building power wiring load circuit.

13. The method of claim 12 where the DC load comprises a receiver adapted to receive the data signal.

14. The method of claim 13 where:
the DC load comprises a ballast; and
the data signal comprises dimming level information for the ballast.

15. The method of claim 13 where the DC power supply and the transmitter are located at a power distribution unit.

16. The method of claim 13 where:
the DC power supply is located at a power distribution unit; and
the transmitter is coupled to the building power wiring load circuit at a location remote from the power distribution unit.

17. The method of claim 13 where the transmitter is integral with an input device.

18. A power distribution unit comprising:
a DC power supply adapted to provide a DC power bus on a first building power wiring load circuit;
a relay adapted to provide AC power on a second building power wiring load circuit; and
a controller arranged to provide central control functions to the power distribution unit.

19. The power distribution unit of claim 18 where the DC power supply is capable of bi-directional power flow.

20. The power distribution unit of claim 18 where the relay is capable of bi-directional power flow.

21. A power distribution unit comprising:
a first DC power supply adapted to provide a first DC power bus on a first building power wiring load circuit;
a second DC power supply adapted to provide a second DC power bus on a second building power wiring load circuit; and
a controller arranged to provide central control functions to the power distribution unit;
where the first DC power supply is capable of bi-directional power flow.

22. The power distribution unit of claim 21 where the first DC power supply comprises a connection for a regenerative power component.

23. The power distribution unit of claim 21 where the first DC power supply is capable of outputting power through a power input connection.
